(19) United States
(12) Patent Application Publication
(10) Pub. No.: US 2003/0135587 A1
(43) Pub. Date: Jul. 17, 2003

(54) Method and system of state management for data communications

(76) Inventors: Andrew Fisher, Victoria (CA); Michael R Levy, Victoria (CA); Jonathan Swoveland, Victoria (CA); Owen Matthews, Victoria (CA)

Correspondence Address: Leffert Jay & Polglaze, P O Box 581009, Minneapolis, MN, 55458-1009, US

(21) Appl. No.: 10/182,034

(22) PCT Filed: Jan. 24, 2001
(86) PCT No.: PCT/CA01/00046

(51) Int. Cl. G06F 15/16

(52) U.S. Cl. 709/219; 709/203

(57) ABSTRACT

Many computer networks including the Internet and World Wide Web applications, use “stateless” protocols in that each request for information is independent of any other requests. However, many applications require state to be managed in some way, for example, a server remembering that a client submitted an acceptable password earlier in a session. The present means of managing state such as using cookies or complex URLs with embedded state, add load to the system resources. The invention lies in maintaining (26) the state on the client side, between a local browser and micro server, and only uploading (28) processed data to the remote server when required.

The present invention relates generally to computer networks, and more specifically, to an improved method and system of state management for data communications.

### BACKGROUND OF THE INVENTION

It is well known that data communication networks such as the Internet, Wide Area Networks (WANs) and Local Area Networks (LANs), offer tremendously efficient means of organizing and distributing computerized data. These efficiencies have resulted in their widespread acceptance for both business and personal applications. For example, the Internet is now a common medium for operating online auctions, academic and public forums, distributing publications such as newspapers and magazines, uploading and storing personal data, and performing electronic commerce and electronic mail transactions. However, the existing methods and systems of implementing such services have limitations which hinder their efficiency and reliability, preventing even greater acceptance and use. Specifically, for World Wide Web (Web) applications, there is no simple and reliable way to provide state management of user sessions.

The Internet consists of a vast interconnection of computers, servers, applications, routers, computer networks and public telecommunication networks which allow two parties to communicate via whatever entities happen to be interconnected at any particular time. The World Wide Web, a subset of these Internet resources, has become a ubiquitous model for information interchange that supports a wide variety of information formats and provides a simple and convenient user interaction model.

The Web uses the client/server model of communication in which a computer user or application (a client) requests and is provided a service (such as sending a Web page) by another computer (a server) in the network. The client/server model, in fact, has become one of the dominant architectures in network computing. In the typical client/server model 10 as presented in FIG. 1, one server 12 is activated and awaits requests from multiple clients 14. Typically, multiple client programs share the services of a common server program. Relative to the Internet, a Web browser is a client program that requests Web pages, files or other services from a multitude of Web servers located anywhere on the Internet.

Other program relationship models also exist including master/slave, where one program is in charge of all other programs, and peer-to-peer, where either of two programs is able to initiate a transaction. As well, multi-tiered models such as the three-tiered application server model as shown in FIG. 2, are also common. In FIG. 2, clients 14 use their Web browsers to request Web pages or files from the Web and/or application server 18. The Web and/or application server 18 in turn, has access to a corporate database 20. This arrangement provides a number of advantages over the simple client/server model of FIG. 1, for example:

1. it provides security by preventing direct access to all of the corporate database's 20 contents by clients 14; and

2. it allows processing to be performed on the data at the Web and/or application server 18, rather than sending only raw data to the clients 14.

Although these different models may vary the roles of the applications software and higher level protocols, they typically use the same basic transfer protocols.

Presently, the systems that make up the Internet comprise many different varieties of computer hardware and software. In general, this variety is not a great hindrance as the Internet is unified by a number of standard transport and application protocols. The Internet relies on TCP/IP, a suite of transport layer protocols, to move information from point to point in the network. Higher layer application protocols, such as Hypertext Transfer Protocol (HTTP), the File Transfer Protocol (FTP), Telnet, and the Simple Mail Transfer Protocol (SMTP) use TCP/IP, but have added functionality to make particular tasks more efficient and convenient.

HTTP, for example, is the set of rules for exchanging information on the Web, including text, graphic images, sound, video, and other multimedia data. HTTP also allows files to contain references to other files whose selection will elicit additional transfer requests, these references being referred to as hypertext links.

Generally, a Web server is a program, running on a server machine and connected to the Internet, that is designed to wait for HTTP requests and handle them when they arrive. Typically, a Web server will handle thousands of requests per hour and frequently host multiple “virtual Web servers” or Web sites. A Web server frequently has many Web applications associated with the Web sites although popular Web sites require multiple load-sharing servers in order to successfully handle the volume of requests.

A Web browser is an application program that runs on the client and provides a way to look at and interact with the information on the World Wide Web. A Web browser uses HTTP to make requests of Web servers throughout the Internet on behalf of the Web browser user. Currently, most Web browsers are implemented as graphical user interfaces.

When the Web browser user enters file requests by either “opening” a Web file, typing in a Uniform Resource Locator (URL), or clicking on a hypertext link, the Web browser builds an HTTP request and sends it to the Internet Protocol address indicated by the URL. The HTTP software in the destination server machine, receives the request and, after any necessary processing, the requested file or information is returned as a Web page. A Web application is a collection of Web pages and utility programs available on a Web server, for the purpose of providing a specific service or function such as making an airline reservation, or searching for and downloading newspaper articles. A Web form is a specialized Web page used to gather user input data.

The HTTP protocol is a stateless protocol, that is, messages between the browser and the Web servers are treated as independent messages. The protocol does not provide information in the message to allow the servers, or the browsers, to determine that one message is a sequel to another. In the initial deployment of the HTTP and the Web as a vehicle to exchange static pages or files, the stateless operation was very efficient but more recently, as the number of Web applications and their complexity has grown, state management over this stateless channel has been a significant problem.

More complex applications often require state information in order to manage a user session. Secure sessions such as banking, making airline reservations or on-line shopping are common examples. Typically, the user is only required to enter his user-id and password once, to log-in to a session. This log-in provides security in the form of user authentication but it is also allows the user to complete multiple tasks without the need to reenter data that is common between the tasks. That is, although each task may consist of multiple request and Web page communications between the client and server, the system state “remembers” that the user has logged in, and does not require new log-in data with each request.

Of course, state must also be maintained for multi-page sessions without a log-in, when the results of one part of the session will impact the nature of a subsequent part of the session. For example, a survey which has different questions for seniors, adults, and children will generally have one page with the common questions and separate pages that would be displayed based on the age data provided by the client. The type of user determines the “state” of the communication which must be maintained in some manner. Of course, a Web application may also choose to break up an application into multiple pages just to make the page size more manageable for the developer, the user or both.

Thus, state information is required by many Web applications to manage user sessions. Because state is not inherent in the HTTP protocol, a variety of attempts have been made to manage state in Web applications. Each of these attempts has significant shortcomings:

1. Cookies: A cookie is a unit of data that is sent by a Web server to a Web browser, where it is stored on the client for future use. Each time the browser communicates with the same server, the cookie is returned to the server. The browser can support different cookies from many servers. There are two common methods of using cookies

a. Identification (ID) only: The server writes a string that identifies the user and perhaps a session. Then when the ID is returned by the client with a subsequent request, the server can use the ID to index a data base containing saved information for the user. While this works well for some applications it has several problems including:

i. additional server processing is required to retrieve the user data, consuming valuable server resources (processing cycles and memory) and increasing the effective cost to provide the service;

ii. if the user aborts the task the server continues to save session data for the user occupying valuable memory. A process to remove “dead” sessions must be created, along with a rule to determine when a session is considered dead. This consumes system resources and may result in active data being erroneously discarded;

iii. load-sharing servers (that is, the use of multiple servers for the same Web site) will require adaptive software to make the state available across the server group. In a load sharing environment a client request will normally be passed to the least busy server, however, the client will only return a cookie to the same server that issued it, in the interests of privacy and security. Software to work around the problem can be generated but is an additional expense and, again consumes valuable resources; and

iv. users may disable the cookie feature of their browser to protect their privacy (for example servers will not be able to track, in this way, use of a particular service) or, alternately, users occasionally delete their cookie file, eliminating the session record. If a cookie is blocked by the client, or accidentally erased, then the state is lost and the client must repeat whatever steps were required to create that state;

b. All state data: The server can write all state data to a cookie to avoid having to maintain a database of state data. Problems with this method, in addition to those mentioned above, include:

i. most browsers allocate only a relatively small amount of memory space for saving cookies. Applications requiring a lot of data may not be able to save it as a cookie; and

ii. cookies are returned with every message to the originating server. If the cookie is large or there are many cookies in the session, it can add significant load to the communications channel;

2. Web Page Data: The Web server can add selected state information to Web pages sent to the browser, and when the user completes a step, the Web page data, including the state information, is sent back to the Web server. The state information, which may be either a user/session identification or all state data, is most often stored in “hidden fields” on a Web page. This method suffers from many of the same problems as state control with cookies as well as other problems. For example the Web pages used are specific to each user and session, thus they cannot be cached, creating an even higher load on the communications network and the originating Web server.

“Caching” is the storing of recently used Web pages on a device other than the originating Web server. If the user requests the same Web page a second time, the cached copy can be obtained, reducing loading on the communications channel and on the server, and reducing the response time for the user. The ability to cache pages is an important efficient feature of the Web. Caching may be performed by the user computer, or by servers at intermediate points along the communication channel, for example, at an office gateway. Examples of applications where caching plays an important role include:

a. a shopping task, say for books, where the user visits the same product selector page several times, to select and view potential purchases. The same selector page may be displayed many times during the user session; and

b. a clipart edit and upload session where a user must cycle through pages for selection, edit, and upload for each item to be uploaded. If the user was to select, edit and upload twenty items, and only one Web page is needed for each operation, three Web pages are required from the Web server (each of select, edit and upload), but each is used twenty times. With caching, only three requests would have to be sent to the Web server to get these three pages. Without caching, sixty requests would be required;

3. Applet: An applet is a small “helper program” which can be downloaded with a Web page to increase functionality on the client side. While applets are useful for some tasks they are not a general solution to the state management problem. First, they do not persist across Web pages (trips to the server), so they must be downloaded each time they are used. This results in additional loading on the server and communications. Second, not all browsers support applets, so the use of applets can complicate or present a “universal access” model for the application;

4. Plug-in: A plug-in (or an equivalent such as an ActiveX control) is another popular type of “helper program”, which is downloaded once and stored on the client. Unfortunately these programs are browser specific, and are not supported at all by some browsers, making the deployment and maintenance of plug-ins more difficult and the use of plug-ins less useful as a state management technique for limited scope applications. As with the applet, an instance of a plug-in does not persist across pages making it less useful for state management in complex applications.

To summarize, while Web based applications have increased in terms of capability and complexity well beyond the initial design intent for the Web, there has not been a corresponding improvement in the system capability to manage the user session in an efficient and effective manner. Situations that are of particular concern, with respect to state management, include:

1. user must enter bulk or complex data requiring multiple forms; especially if subsequent forms depend on preceding data;

2. user must select data from local file system devices; and

3. multiple cycles, or an indeterminate number, may be required, as in editing or shopping.

Issues of concern include:

1. server side scalability, the ability to handle an increasing number of client visits, or an increase in service complexity, due to:

a. processing cycles required for handling service requests;

b. response time for service requests, including both latency and throughput; and

c. load sharing (multiple server) implementation constraints;

2. network loading due to transmission of data for the purposes of:

a. altering the data for presentation and returning it;

b. effects that cause pages not to be cached; and

c. repeat transmission of Web objects such as applets;

3. client side “helper” upgrades for corresponding server side capability improvements;

4. reliability and quality of service; and

5. multiple platform compatibility and support issues.

In short, to be successful a Web application must be cost effective and user desirable; convenient, fast, and easy to use.

There is, therefore, a need for a method and system of managing state during user sessions, which improves upon the problems described above. This design must be provided with consideration for ease of implementation and recognize the pervasiveness of existing infrastructure.

### SUMMARY OF THE INVENTION

It is therefore an object of the invention to provide an improved method and system of state management for data communications, which obviates or mitigates at least one of the disadvantages of the prior art.

One aspect of the invention is broadly defined as a method of session management for a stateless network comprising the steps of: downloading data from the remote server side to the client side; effecting state dependent processing of said data between a browser and a micro server on the client side; and uploading said processed data to said remote server.

### BRIEF DESCRIPTION OF THE DRAWINGS

These and other features of the invention will become more apparent from the following description in which reference is made to the appended drawings in which:

FIG. 1 presents a block diagram of a client/server network as known in the prior art;

FIG. 2 presents a block diagram of a three-tiered Web server and/or application server as known in the prior art;

FIG. 3 presents a flow chart of an exemplary method in an embodiment of the invention;

FIG. 4 presents a block diagram of an exemplary apparatus in an embodiment of the invention;

FIG. 5 presents a bock diagram of a software architecture in an exemplary method of the invention;

FIGS. 6a and 6b present a flow chart of a preferred method of the invention; and

FIG. 7 presents a block diagram of a software architecture in a preferred embodiment of the invention.

### DESCRIPTION OF THE INVENTION

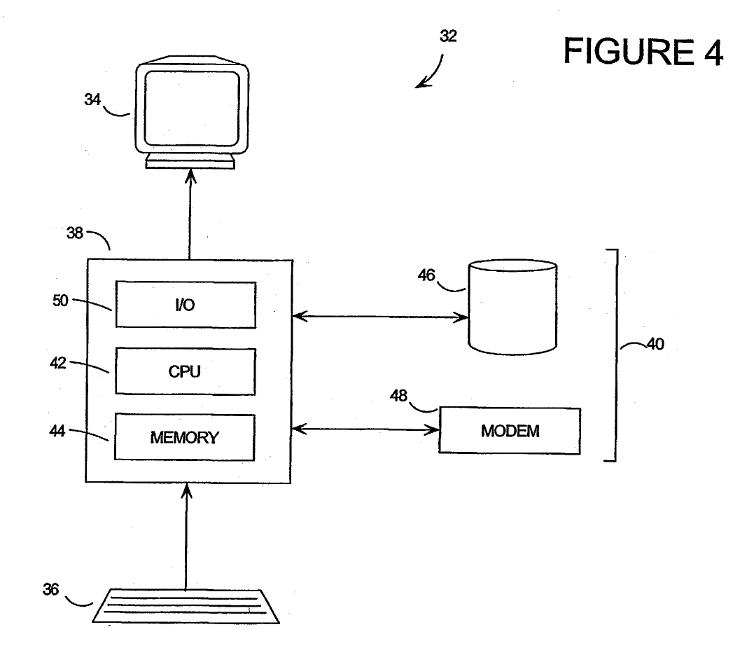

A method which addresses the objects outlined above, is presented as a flow chart in FIG. 3. This flow chart presents a method of session management where the server downloads data to a client at step 22, which the client receives at step 24.

This data would generally be in response to a request from the client, but as will be explained hereinafter, may be initiated in other manners. The client then performs state dependent processing on the client side, at step 26, by communicating between a browser and micro server, both on the client side. When the state dependent processing is complete, the client uploads the resulting data to the server at step 28.

As outlined in the Background above, there are many network applications which require state to be maintained between the client and the server in the network. However, many communication protocols are “stateless” in that they are optimized for the request and return of specific pages or data without regard for any past interactions between the two parties involved. The HTTP protocol used on the World Wide Web is an example of such a stateless protocol. Heretofore, there was no effective way to maintain state between the client and server over a stateless network without encountering the problems identified in the Background.

The invention provides a method for the client to maintain state and session specific data for subsequent use such as effecting decisions in processing of subsequent data and uploading the resulting data to the server at the end of the session.

This is done by placing a micro server on the client side, so that state can be maintained between the micro server and the client browser. Within the client envelope, state may generally be maintained in any manner known in the art provided the client computer has the resources to do so. While back and forth communications between a local browser and a remote server to maintain state places a very large load on the network and server resources, the same communications are generally insignificant if the they are contained with the client computer.

The local server is described as a “micro” server as it contains information pertinent only to the local client, and the tasks at hand. In contrast, the remote Web server will generally maintain data and information pertaining to many clients. A micro server offers many advantages over a Web page emulator of the sort known in the art, as it communicates with the client browser using HTTP, and can perform the same functionality as the remote Web server. Emulators, for example, may be able to present edited Web pages in the format that may appear on a remote server, but cannot, for example, transfer data and state from one page to the next.

In this manner the invention overcomes many of the obstacles encountered in the prior art, including:

decreasing the amount of data that is downloaded from the server through a combination of reduction or elimination of: state information, data that is repeatedly transmitted, and transient data from client-server transactions. This results in less loading on the server and the network;

increasing the use of cached data and Web pages by eliminating session specific data, making Web pages commodity items. Again, this results in less loading on the server and the network;

efficient handling of intermediate data requests by elimination of processing to determine current session state. The server continues to receive requests and deliver data, functions it is most efficient at, but does not need to process intermediate state data, resulting in a significant server load reduction;

eliminating browser incompatibility. As the interface between the micro server and the Web browser is the same as that between the Web server and the Web browser, the system of the invention being compatible with all Web browsers capable of running with the Webserver;

elimination of “long term” storage of state data, and the need for utilities to clean up “dead” sessions, allowing more user sessions to be handled by the same server; and

load-sharing servers can operate independently without the need for specialized software to maintain user state information across the servers, reducing overall system load.

In general, the user benefits in terms of improved response times and convenience, while the service provider will benefit in terms of scalability and cost reduction. The reduced network load will also provide a cost saving for the network operator.

With the invention, the server manages the overall user session but more of the detail steps, and of course, the steps requiring the maintenance of state, are processed on the client. This improves the overall effectiveness, quality of service, efficiency, and reliability of the system. As described in greater detail hereinafter, the client of the preferred embodiment further includes the ability to fetch new agents or upgrade the system transparently, which contributes to the reliability of the system.

This implementation also allows the client to leverage their existing Web browser software. As described above, the use of Web browser plugins or applets may require the client to obtain new browser software to be compatible with the choice of helper programs available. With the invention, the Web browser only processes conventional HTML requests, and does not require plug-ins of applets to manage the session. Therefore, the client can continue to use an old version of his Web browser.

On the server side, the Web server no longer has to generate software code specific to each helper program that a user may have, or generate universal code that is responsive to which of several types of helper program the user may have. Only a single set of instructions are required for any particular functionality. This increases reliability due to the decreased complexity and decreases the server resources because only one simple set of software code is required. As well, this frees up server processing cycles because received packets do not have to be compiled from various incoming formats into a uniform format.

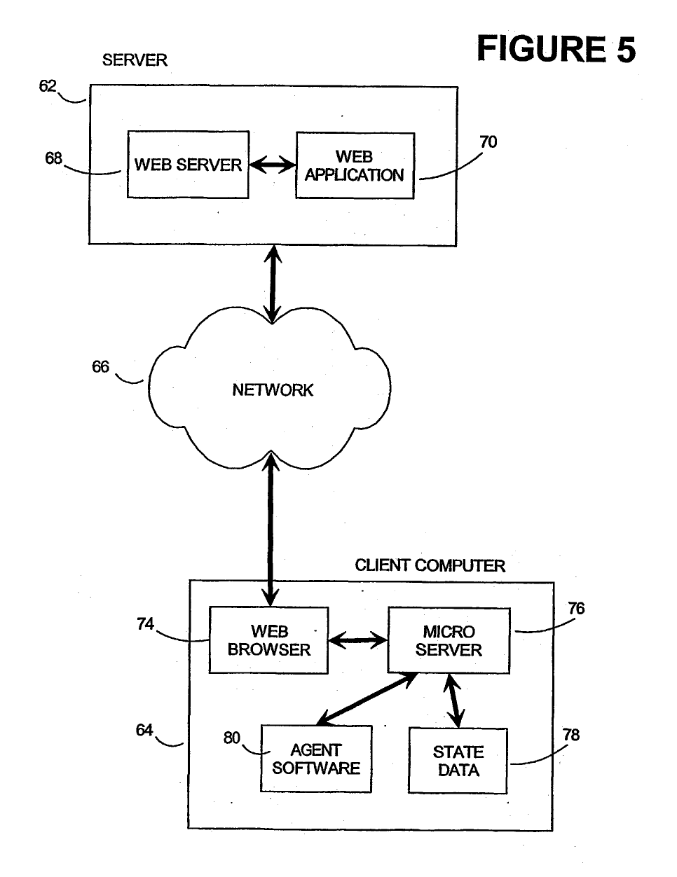

An example of an apparatus upon which the invention may be performed is presented as a block diagram in FIG. 4. This computer system 32 includes a display 34, keyboard 36, computer 38 and external devices 40.

The computer 38 may contain one or more processors or microprocessors, such as a central processing unit (CPU) 42. The CPU 42 performs arithmetic calculations and control functions to execute software stored in an internal memory 44, preferably random access memory (RAM) and/or read only memory (ROM), and possibly additional memory 46. The additional memory 46 may include, for example, mass memory storage, hard disk drives, floppy disk drives, magnetic tape drives, compact disk drives, program cartridges and cartridge interfaces such as that found in video game devices, removable memory chips such as EPROM, or PROM, or similar storage media as known in the art. This additional memory 46 may be physically internal to the computer 38, or external as shown in FIG. 4.

The computer system 32 also includes a communications interface 48 for communicating with an external network. Examples of the communications interface 48 can include a modem, a network interface such as an Ethernet card, or a wireless network interface. Software and data transferred via communications interface 48 are in the form of signals which can be in an electronic, electromagnetic, optical or other form.

Input and output, to and from the computer 38, is administered by the input/output (I/O) interface 50. This I/O interface 50 administers control of the display 34, keyboard 36, external devices 40 and other such components of the computer system 32.

The invention is described in these terms for convenience only. It would be clear to one skilled in the art that the invention may be applied to other computer or control systems 32. Such systems would include all manner of appliances having computer or processor control including telephones, cellular telephones, televisions, television set top units, lap top computers, personal digital assistants, industrial control equipment, manufacturing equipment, surveillance equipment, and transportation vehicles such as automobiles.

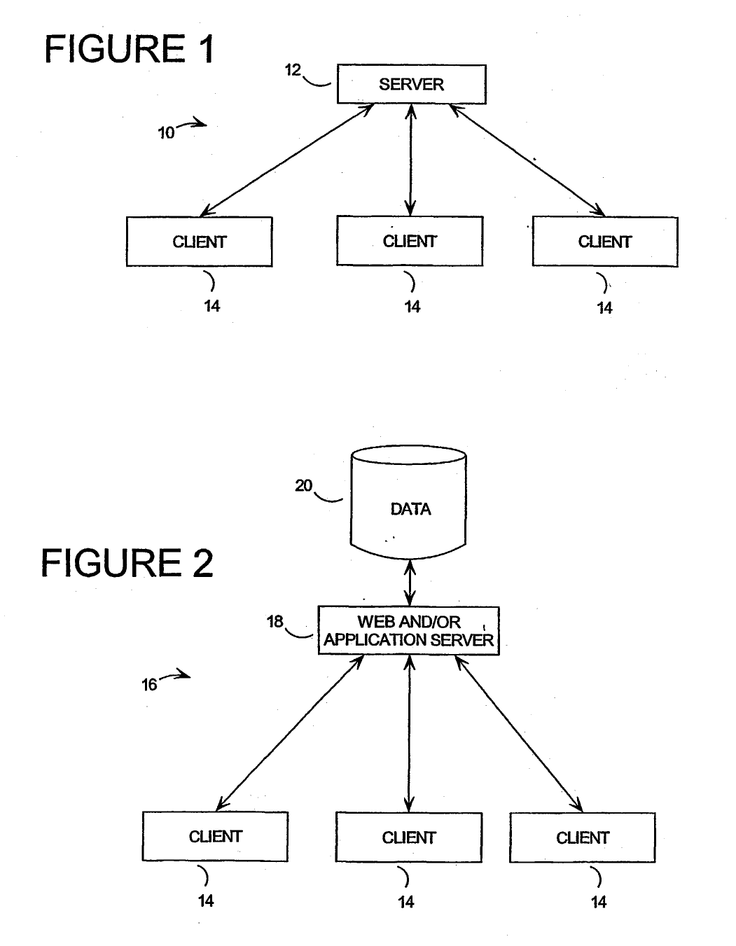

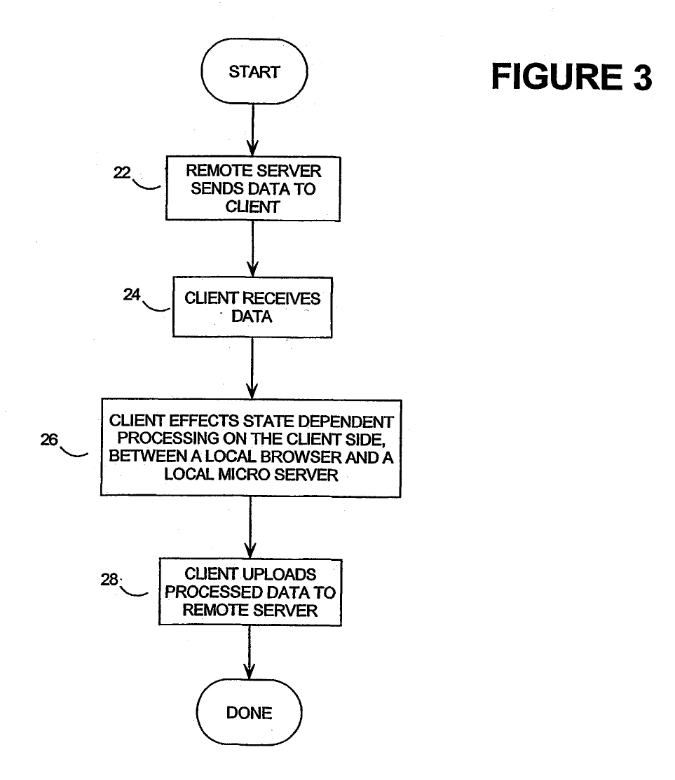

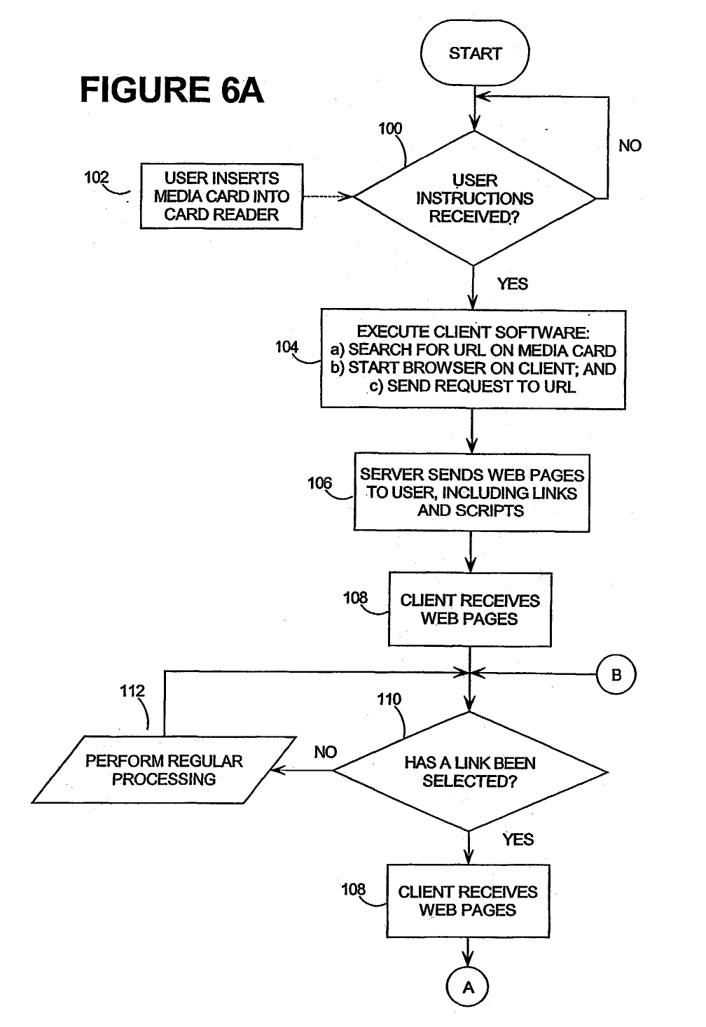

FIG. 5 presents a block diagram of an exemplary software architecture applied to an Internet environment, such as those presented in FIGS. 1 or 2. This system includes a remote server 62, as known in the art, which waits for client requests and satisfies those requests, and which may access various internal or external databases or resources. The client 64 is a computer or similar computation device, such as one presented in FIG. 4, that can communicate with the server 62 via communications network 66.

The server 62 hosts one or more Web servers 68 and may host other types of servers such as databases, which may or may not be related to the services provided by the Web server 68. The Web server 68 is the software program that analyses the client requests, locates the information required, performs any required computations, and formats and transmits the responses. To provide services other than supplying data the server 62 may also contain one or more Web applications 70 which are usually collections of Web pages, template pages, utilities or programs, and services which are called upon to assist in completing requests from the client 64. At the client location, a Web browser 74 sends user requests to the Web server 68 and receives the responses. The use of a standard Web browser 74 with standard Web browser controls minimizes the quantity of code needed to deploy the invention, as well as maximizing end user compatibility and leveraging the end user's existing software base.

In the system of the invention, the client 64.also contains a micro server 76, and a means to store state data 78. The client may also contain agents 80 to perform specialized tasks such as data format translation and interfacing system components.

In general, a user interfaces with a Web browser 74 or similar program to request information or services from a server 62. In the system of the invention the user request may be initiated by simply entering a URL into a browser locator field, or by clicking on a hypertext link. As will be described in the preferred embodiment hereinafter, the request may also be initiated automatically when a pre-programmed memory medium is activated. In other cases the request may be initiated by another program running on the client 64 computer.

A micro server 76 interprets directives included in the HTTP messages from the browser 74 and, may, according to the directives: store state information, interface various agents, resolve template pages to display to the user at the Web browser 74, or format and send requests to the server 62.

Software agents 80 are small software modules with dedicated tasks, such as converting data from one format to another, or interfacing with system peripherals to obtain certain data. Agents 80 can be stored on the client 64 in a library but can also be downloaded when required, or updated when new versions are available. The implementation of these agents 80 will be described in greater detail hereinafter.

In the preferred mode of operation within the network 66, the communication between the client 64 and server 62 is stateless. That is, each message is treated as an independent entity rather than one of a set of connected messages.

Preferred Embodiment

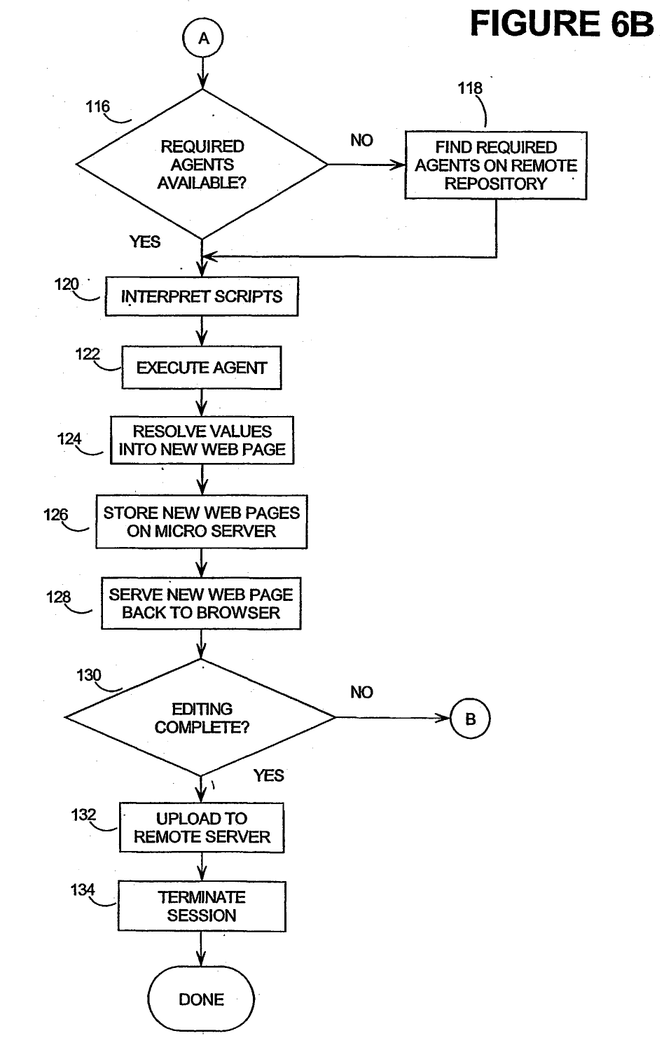

The preferred method of the invention is presented by means of a flow chart in FIGS. 6a and 6b. As the preferred application of the invention is in a Web environment, the preferred method will be described in that context. It is understood that the invention may be equally applied to other data communication environments which would be known to one skilled in the art.

As well, the routine presented in FIGS. 6a and 6b is greatly simplified in the interest of making it easy to understand. The added complexity necessary to implement the invention will vary with the platform being used, and is well within the ability of a skilled technician. For example, the method of the invention begins at step 100, where the client sits in a loop awaiting input instructions from the user. In a real application, the monitoring of instructions per step 100 would not likely exist as a simple loop, but would be effected in the manner of the operating system the invention is being applied to. Typically, the operating system would present a graphical user interface (GUI) to the user, who would input instructions using a mouse, keyboard, or similar device. When inputs are made by the user, hardware interrupts would call the CPU 42, and the operating system would receive the user's instructions. When these instructions are received, the operating system would call a corresponding software routine to be executed.

In the preferred embodiment, a user input is detected at step 100 when the user inserts a special media card into a media reader at step 102. As will be described in greater detail hereinafter, the media card is pre-programmed to initiate a software application session. Other means of initiating a request, in other instances of the invention, might include a user selection on the browser or an input from another program.

This media reader is preferably connected to the user's computer using one of the powerful new standards available, and in particular, USB (universal serial bus). Computer peripherals, such as printers, scanners, tape drives, and media readers have traditionally been connected to the computer using serial ports, parallel ports, and SCSI (small computer system interface) ports. Recent interconnect systems, such as USB and Firewire (IEEE standard 1394), add a number of convenient features and are becoming the preferred method to connect devices to a computer.

In particular, USB offers:

1. hot-swapping, which allows connection and removal of devices without powering down or restarting the system;

2. Plug-and-play, which allows the new component to operate and interact with the system without the user having to perform implicit installation steps;

3. improved throughput with speeds up to 12 M bits/second and beyond;

4. multiple device connectivity; and

5. power distribution, that is, devices with low power requirements may be powered directly by the USB and do not require an external power source.

At step 104, the client software then initiates the session, which may include performing the steps of:,

1. searching for a uniform resource locator (URL) or Web address, for the remote server 62 on the special media card;

2. starting execution of a browser 74 on the client 64; and

3. sending a request to the remote server 62 at the pre-programmed URL.

Session initiation may also include other operations such as checking to see whether a Web browser is running, checking the validity of a licence for the micro server 76, performing a local log-in operation, and/or executing a script provided by the card reader input device.

At step 106, the server 62 responds to the request from the client 64 by downloading the requested Web page or template, with embedded directives for the micro server 76 and, optionally, a dictionary of required agents. The client 64 then receives the requested. Web page or template at step 108, using his browser 74.

In the development of interactive applications, it is often necessary to incorporate specific data from the current state into a specific data page. A “template” is an incomplete data page that includes special-purpose tags, which are replaced by particular data that is derived from the state information. The process of processing a template whereby the tags are replaced is known as “resolution”. The concepts of tags, templates and resolution are well known in the art.

Also, note that the embedded directives and/or dictionary, commence with a character that will cause the user's Web browser to disregard it, rather than trying to read or display it and causing the Web browser to crash. It is preferred that the embedded information request code commence with a comment code which will cause the Web browser to ignore it. As comment characters are relatively standard in the industry, this allows the method to be applied to any type or version of Web browser. Of course, dedicated or non-comment characters could be used, but this may compromise the universality of the implementation.

As well, it is not necessary for the embedded information request code to be written in a high level style, but it is preferred, as high level languages are easier to read. This makes the development, editing and troubleshooting of the embedded information request code easier.

It is also not necessary to include a dictionary of software agents required, as it is common to call upon agents, subroutines, function libraries and the like, as code is being compiled. However, when the invention is applied to Internet based applications, the time required to obtain software agents from a remote location may be greater than any of the other operations, so it is more efficient to source the software agents as early as possible so they are being downloaded while the balance of the code is compiling or running.

Of course, the balance of the Web page's contents has no relevance to the invention, so it may be coded with XML, ActiveX, Java, SGML, HTML or other similar languages that may become available from time to time. Thus, embedded directives are passed by the browser 74 to the micro server 76 who receives and acts on these directives as part of step 108. In the preferred embodiment, the initial Web page downloaded to the client 62 may include regular instructions which may be executed, and also special links to the local micro server. If one of these regular instructions is received at step 110, it is executed at step 112. If one of the special links is selected by the user, processing proceeds to step 114, where a request is sent to the micro server 76. The micro server 76 is easy for the system to locate because it has IP address 127.0.0.1, which is defined universally as the local host. This request may also contain scripts and directories of agents, which are handled as described hereinafter.

As part of the execution of the embedded directives, the client software determines whether the agents are available on the client side at step 116. This may be done by maintaining a table of local software agents and their locations, or by searching for them on the local storage media.

If new software agents are required, they are obtained at step 118. In the preferred embodiment of the invention, the client software will be pre-programmed with user preferences including where to look for software agents. It is expected that software agents will be stored in one or more central registries on the Internet which provide standard benefits to the user such as security and help assistance.

It would be expected that the market would prefer to dynamically download new software agents from a reliable and predetermined source rather than facing the security and reliability risks of an open market, however, the invention may be applied in an open manner.

Next, the client software interprets the embedded scripts at step 120, and executes the identified agents at step 122. These steps may be used to perform a wide variety of functionality including locating and harvesting data, and converting data into the format desired by the remote Web server 62. Preferably, these steps are automated, but addressing the location of certain data files may require user interaction. For example, the scripts and agents could access a scanner or digital camera on the client, uploading image data and converting it to a desired format. This could be performed in a completely automatic way, transparent to the user. As another example, one would expect clients to have standard and often requested data files such as those usually required to set up a Web account. This file would contain data such as name, address, email address, password data and biometric data.

If all the information that a particular Web server has requested is not contained in the automatically accessed files, then the user may be queried for either the location of the required data, or the data itself. These data are stored in local session variables.

A dynamic link library (DLL) may be used to execute the formatting agents on the data. A DLL is a collection of small programs, any of which can be called when needed by a larger program that is running in the computer. For example, the small program that allows a larger program to communicate with a specific device such as a printer or scanner is often packaged as a DLL file.

The use of DLL files provides the added advantage that they are not loaded into random access memory (RAM) together with the main program, saving space in the RAM. A DLL file is not loaded and run until it is required. DLL files are dynamically linked with the program that uses them during program execution rather than being compiled with the main program. UNIX and Macintosh™ platforms do not use DLLs but have similar utilities that would be known to one skilled in the art.

Next, the data stored in the local session variables are resolved into a new Web page or pages, at step 124. These Web pages are stored on the micro server 76 at step 126 and may be served back to the client browser 74 in response to appropriate HTTP requests from the browser 74, at step 128.

The data is transferred from the micro server 76 to the browser and back using HTTP protocol for several reasons. Firstly, because of HTTP's widespread use, a large number of software developers are familiar with it and how to develop code for it. Secondly, and more importantly, the use of HTTP allows the micro server 76 to simply look like another server to the Web browser 74. This allows the micro server 76 to act outside the security model of the Web browser 74, so it will be allowed to access devices on the client's system 64. Typically, Web browsers 74 are 20 not allowed such root access to prevent malicious or defective code arriving via the communications network, from damaging the client's system 64.

This secure “sandbox” is expanded by use of the invention without fear of security breaches provided that secure software agents are used. The invention allows software agents to have root access, and if the software agents themselves are controlled and secure, the security of the system is not comprised. As will be described hereinafter, it is preferred to create a central repository of such controlled and secure software agents which is available to users over the Internet. Although users may obtain software agents from any supplier, it is expected that they will prefer to rely on such repositories to ensure that only secure software agents are used.

Again, fixed applications have been available in the past that have also had such root access over a communications network, but these solutions have been limited to fixed applications with predetermined formats. The invention provides for root access that is inherently generic and flexible.

In order to utilize the lowest common denominator user interface (HTML), the invention applies a resolution engine capable to taking as inputs the output from a HTTP post call, and a standard HTML template and producing a resultant form. An HTTP post call is an HTTP method used to send a block of data to a server to be processed in some way and is well known in the art. Furthermore, client side data can also be seeded into the template by adding it as though it came from the HTTP post input stream.

Standard Internet security methods such as firewalls, password verification, authentication, and encryption techniques may be applied to the invention. As one must ask software agents to enter their machine, simple authentication and trust may be used. Generally, a user is breaking out of the sandbox only once, and bypassing security checks once downloading.

At step 130, the determination is made whether the session is made whether the session is complete. If not, control returns to step 110 of FIG. 6A. If the session is complete, the client will generally upload the data they have been processing to the remote server 62 at step 132 and the routine is terminated at step 134. The termination process may consist of a request to terminate being sent to the remote server 62, which returns a session termination Web page to the client 64. The micro server 76 then processes the termination page, transferring the results to the browser 74 to be displayed. The client may then delete the state data and terminate the session. This termination process may, of course, vary.

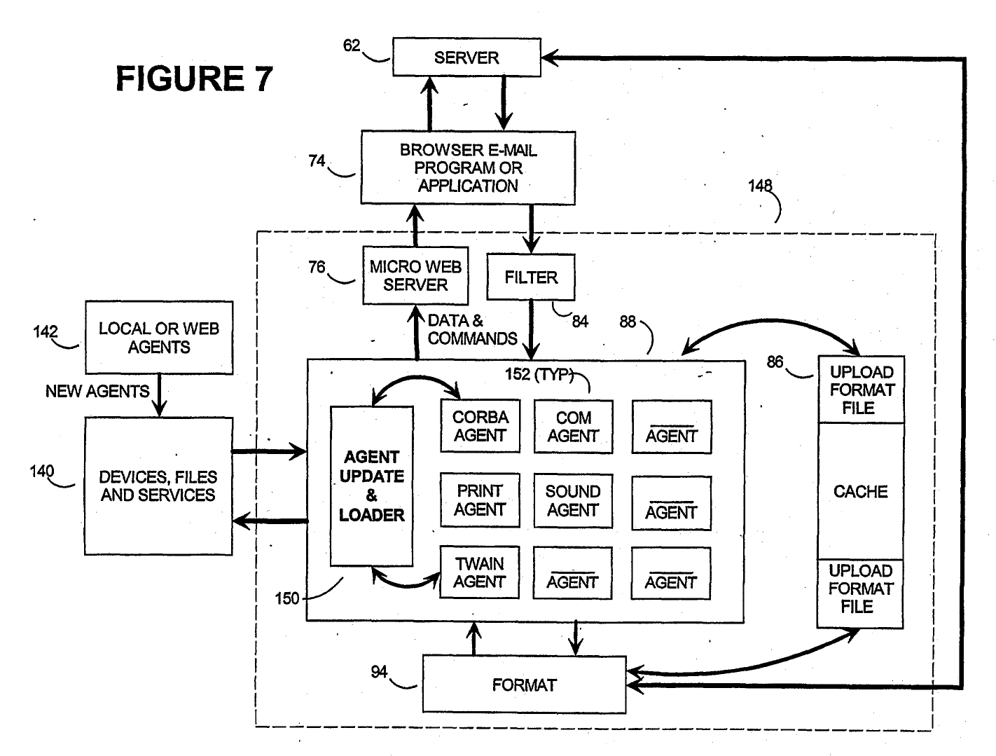

FIG. 7 presents a block diagram of a software architecture for implementing the invention in a preferred manner of the invention. The Web server 62 and Web browser 54 may be the same as those described with respect to FIG. 5. In the preferred embodiment, a session manager 148 resides on the client 64 and manages the client side processing of the invention. The session manager 148 preferably has the architecture shown, and has access to the devices, files and services 140 of the local computer system 32.

These devices, files and services 140 may Include those resources described with respect to FIG. 4 above. This would include, for example, the display 34, keyboard 36, CPU 42, internal memory 44, additional memory 46, communications interface 48 and input/output (I/O) interface 50. Allowing the Web server and/or application server 62 access to such devices allows far more elaborate applications to be implemented, as well as saving client resources, work and time. For example, it allows:

1. a Web server to have direct control over a user's digital camera so that it can harvest picture files to be uploaded to a server, or even authenticate the user visually. Using a traditional Web system architecture, the client browser would not have access permissions required to access or control the camera; and

2. a Web application to perform multiple step processing on the client, such as obtaining picture files from a device, or searching for them on a hard drive, editing and/or reformatting the files, and assembling the files into a message sent to the server. Again, existing system architectures would not allow a browser to access such devices, and would not be able to perform such sophisticated processing on the client side.

The storage location for new software agents 142 has been shown as a separate block from the perspective of the software, but it is understood that software agents may be stored on the same internal memory 44 or additional memory 46 such as a CD-rom, on which the other local software entities are stored. When a required software agent is not available or must be upgraded, the new agent may be downloaded from a remote repository. Of course, new software agents are preferably stored at a central depository accessible via the Internet, as described above. This central repository may even reside on the same server 62 that the user is accessing.

The session manager 148 itself includes a filter 84 which removes the information requests from the received Web pages or templates, and passes the information format and contents to the media engine 88. The media engine 88 itself includes an agent update and loader 150, and a number of software agents 152. These software agents 152 may include, for example:

1. CORBA™, COM™ or other embedded software languages. The current embedded software languages are not flexible or practical as a method of coordinating the format of data being transmitted, however, the invention allows data to be wrapped into a CORBA™ or COM™ object for uploading.

2. Device interfaces for the purpose of “harvesting” files, streaming data, and the like, or for control of the device such as advancing or rewinding a playback mode, deleting harvested file, and the like. As an example, TWAIN is a widely-used standard for registering and launching drivers that are used to capture images as a bitmap from digital imaging devices. For example, TWAIN is commonly included with scanner software packages, running between the scanner hardware and an application, to convert scanner data directly into an application (such as PhotoShop™) where the image is to be worked upon. Without TWAIN, one would have to close an application that was open, open a special application to receive the image, and then move the image to the application where it was to be worked with.

3. Capturing voice streams using a microphone and converting to sound formats such as MP3™, Wave™, RealAudio™ and MPEG.

4. Word processing formats such as Microsoft™ Word™ and Corel™ WordPerfect™.

5. Output formats for printers.

6. Video drivers.

As the data are collected, they are stored in the memory cache 86. The stored data are then passed to a format block 94 which executes the format agents on the cached data, to generate the data file requested by the Web server 62. As noted above, the processed data may be returned either directly to the Web server 62, or via the micro server 76, through the browser 74. This is possible because the data packets are returned using HTTP, so the Web browser 74 assumes that those data packets have been sent from another server and simply passes them on.

This architecture also allows state to be maintained between the browser 74 and the micro server 76 by directing the format block 94 to return HTTP packets via the micro server 76.

Additional Communication Examples

The invention was described with respect to an example presented in FIGS. 6A and 6B, however, it would be clear to one skilled in the art that the bidirectional intercommunication provided by the invention is flexible enough to be applied to many other situations. Several examples are described hereinafter with respect to the Server 62, Browser 74 and client 64 presented in FIG. 5, but this is by no means a complete list:

1. Browser 74 to Server 62

a. In an initial session, the Server 62 could respond to a request for a Web page received from the Browser 74 by verifying access and returning to the Browser 74 a lowest common denominator agent (LCDA) for a given protocol.

b. In subsequent sessions, or service update sessions, the Server 62 could respond to a request for a Web page received from the Browser 74 by verifying access, processing the request, and returning a formatted response to the Browser 74.

2. Browser 74 to Client 64

a. Communications of this type allow the Browser 74 to activate local devices and other resources under the control of the Session manager 148. Such device control is well described with respect to the preferred embodiment above.

b. As well, the Browser 74 may access the Session manager 148 to perform network services. For example, the Browser 74 may consist of legacy word processing software that otherwise would not have access to the Server 62. However, with the invention, the word processing Browser 74 could direct information to the Session manager 148 as a default printer, and the Session manager 148 could convert the information from a postscript format to COM, XML or CORBA or other format to the Server 62.

3. Client 64 to Browser 74

a. In response to a service request, the Session manager 148 may negotiate with other Browsers 74 to achieve the desired objective. The other Browsers 74 may include third party applications, appliances, services and devices.

b. Service delivery from the Session manager 148 to the Browser 74 may require data transformation from the service's specific protocol to a protocol compatible with the Browser 74. For example, the Server 62 could receive a request from the user, via his browser which is an Browser 74, to perform a search using the keyword “Voltaire”. The Server 62 responds to the request from the user, and the user's Session manager 148 can receive the response before passing it on to the application. Based on known user preferences, the Session manager 148 can determine whether the user is likely looking for information on the philosopher and author named “Voltaire”, or the rock band of the same name, and resubmit the request modified for the users preferences. With the response from the Session manager 148, the Server 62 may then perform a search that is tailored to the user's preferences and history, and serve the new response, without interruption from the session manager, back to the application.

4. Client 64 to Server 62

a. This communication allows the Session manager 148 to request services directly from the Server 62. For example, if the Session manager 148 requires a new software agent 152 to comply with a service request it has received in some manner, it may contact the Server 62 directly to obtain the necessary software agent 152.

b. As well, service update sessions may be performed between the Session manager 148 and the Server 62.

5. Server 62 to client 64

a. The Server 62 may provide services directly to the Session manager 148, for example, by providing a new software agent 152 as described above.

b. The Server 62 may request services directly from the Session manager 148 itself. As the Session manager 148 and the Application 54 share the same IP (Internet Protocol) address, the TCP/IP stack can be read by the Session manager 148 when a Server 62 responds to the request from the Browser 74. The Session manager 148 can intervene before the data packets are sent to the Browser 74, hence the Server 62 is contacting the user's Session manager 148 directly, requesting information about the user's preferences, history or other useful data to complete a users request or transaction.

Applications

The invention may be applied to standard Internet client/server applications such as filling out forms and authenticating users. However, an unlimited number of new applications become practical with the added functionality of the invention, for example:

1. television set top boxes for television over IP, with the functionality of the invention embedded into a chipset;

2. remote and automatic, troubleshooting and maintenance of software and hardware systems;

3. telephony over IP where a software codec agent performs the encoding and decoding of the voice packets;

4. more advanced and reliable security techniques, for example, controlling biometric input devices directly to prevent a security breech; and

5. remote medical monitoring and/or diagnosis, either between hospitals or between patients at home, and their doctors or hospitals.

Examples have been shown to demonstrate various aspects of the invention, but the number of variations is by no means complete. Comparable implementations could be made for any computer network device, including personal digital assistants, cellular telephones, fax machines, pagers, point of sale computers, local area networks or private branch exchanges. While particular embodiments of the present invention have been shown and described, it is clear that changes and modifications may be made to such embodiments without departing from the true scope and spirit of the invention.

The invention is described with respect to an application where state is maintained on the client computer. However, the functionality provided by the micro server and the client browser need not be on the same physical computer as described. From the description of the invention, it would be clear to one skilled in the art that state could be maintained by any resources which avoid the bottlenecks and scalability problems of communication back to the original server. For example, in an office environment, a dedicated “state server” could be used which manages state between all of the office users and the Internet. This implementation would not have all of the advantages of the preferred embodiment of the invention,

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

What is claimed is:

1. A method of session management for a stateless network comprising the steps of:
downloading data from the remote server side to the client side;
effecting state dependent processing of said data between a browser and a micro server on the client side; and
uploading said processed data to said remote server.

2. The method of claim 1, wherein said step of effecting state dependent processing comprises editing of said data.

3. The method of claim 2, wherein said data comprises Web page or template data.

4. A method of session management for a stateless client-server network comprising the steps of:
loading a micro server onto the client side; and
loading a browser onto the client side;
whereby the client may download data from a remote server and perform state dependent processing between said micro server and said browser, only updating said remote server as required.

5. A method of session management for a stateless client-server network requiring successive communication steps between said client and said server comprising the steps of:
downloading data from the remote server side to the client side;
effecting state dependent, multiple user tasks, on the client side; and
uploading the edited data to said remote server.

6. A method of improving use of bandwidth and minimizing data volume for stateless communication networks comprising the steps of:
downloading data from a remote server side to a client side;
effecting state dependent processing of said data on a local Web server on the client side; and
uploading said processed data to said remote server.

7. The method of claim 1, wherein said data comprises Web page data, whereby editing can be performed on the client side and viewed on the local micro server, without having to wait for Web page data to be communicated back to the remote server and then returned to the client browser for viewing.

8. The method of claim 1, further comprising the step of:
reading pre-programmed access information from a removable memory medium, via an input device;
whereby administrative control and security mechanisms of the remote software application are managed, transparent to the user.

9. The method of claim 8, wherein said access information comprises user identification, user class, and licence information.

10. The method of claim 9, further comprising the step of:
responding to the insertion of said removable memory medium input said input device, by:
locating and reading a URL (universal resource locator) address on said removable memory medium; and
sending a request to the remote server identified by said URL, for data to be returned.

11. The system of claim 1, further comprising:
an input device for reading a removable memory medium;
said removable memory medium being pre-programmed to identify the user, or class of user, and licence information;
whereby administrative control and security mechanisms of the remote software application are managed, transparent to the user, and said user does not have to perform a multitude of steps to obtain secure access.

12. The system of claim 1, wherein said input device comprises a card reader.

13. The system of claim 1, wherein said input device comprises a plug-and-play card reader.

14. The system of claim 1, wherein said input device comprises a USB (universal services bus) based card reader.

15. A system comprising:
a computer;
a remote server; and
a stateless communication network interconnecting said computer and said remote server;
said computer being operable to:
execute a Web browser program;
execute a first server program; and
maintain state-dependent interaction between said Web browser program and said first server program; and
said remote server being operable to:
execute a second server program;
whereby session state is preserved on said computer, minimizing the need to maintain state between said computer and said remote server.

16. A system comprising:
a computer;
a remote server; and
a stateless communication network interconnecting said computer and said remote server;
said remote server being operable to:
download data to said computer; and
said computer being operable to:
receive data from said server;
effect state dependent processing of said data between a local Web server and a local browser on said computer; and
upload said processed data to said remote server,
whereby session state is preserved on said computer, minimizing the need to maintain state on said remote server.

17. A method of uploading information from a client to a server comprising the steps of:
at said server:
sending a data form to said client (this is the Web page template) which identifies the data required (content for the Web page—images, etc) and specifies the required format for said data; and
at said client:
responding to receipt of said data form by:
obtaining said identified data;
automatically formatting said identified data into said specified format;
inserting said formatted, identified data into said data form, and returning said data form to said server.

18. The method of claim 1 further comprising the steps of: at said client:
identifying a software agent which may execute to format said requested data into said specified format; and
responding to said software agent not being available locally, by downloading said software agent from a remote repository.

19. The method of claim 2, wherein said step of obtaining said requested data includes uploading images.

20. The method of claim 5, wherein said step of locating said requested data includes querying a user to input text via a graphic user interface (GUI).

21. The method of claim 2, wherein said step of receiving said information request includes receiving said information request using a standard Web browser.

22. The method of claim 9, wherein:
said step of sending includes sending said information request as software code embedded in a Web page in a manner that said standard Web browser will not attempt to read; and
said step of receiving further includes filtering said embedded information request from said Web page and passing said filtered instruction to an agent operable to execute said information request code.

23. The method of claim 10, wherein said agent further comprises a micro server for uploading data packets to said browser, for graphic user interface (GUI) control and information control inside the browser.

24. A system as claimed in claim 15, wherein said server is an application server.

25. A computer data signal embodied in a carrier wave, said computer data signal comprising a set of machine executable code being executable by a computer to perform the steps of claim 1.

26. A computer readable storage medium storing a set of machine executable code, said set of machine executable code being executable by a computer to perform the steps of claim 1.

27. A method of Web page editing comprising the steps of:
responding to the insertion of a removable memory device into a memory reader (a USB card reader, or other plug-and-play device) connected to a personal computer by initiating execution of local client software which performs the steps of:
searching for a pre-programmed uniform resource locator (URL) on said removable memory device;
initiating execution of a Web browser on the client side; and
transmitting a request to said remote server at said URL;
said remote server responding to said request by downloading Web pages or templates to said client computer, said Web pages or templates containing links to the micro server software, scripts and/or embedded directives;
said client computer receiving said Web pages or templates;
said client computer responding to a user selecting one of said links to said micro server software by:
responding to a required software agent not being available by obtaining said required agent from a remote repository;
interpreting said scripts corresponding to said selected link;
executing said required agent, which stores its outputs in local session variables;
resolving the values of said local session variables into said Web pages and templates, generating new Web pages;
serving said new Web pages back to said client browser for display; and
storing said new Web pages on said micro server; and
said client computer responding to editing being complete by uploading said new Web pages to said remote server.
